(19) United States
(12) Patent Application Publication
(10) Pub. No.: US 2026/0300201 A1
(43) Pub. Date: Oct. 1, 2026

(54) CONTROLLING CIRCUIT

(71) Applicant: ASMedia Technology Inc., New Taipei City (TW)

(72) Inventor: Chun-Jung Hsu, New Taipei City (TW)

(73) Assignee: ASMedia Technology Inc., New Taipei City (TW)

(21) Appl. No.: 19/231,592

(22) Filed: Jun. 9, 2025

(30) Foreign Application Priority Data
Mar. 27, 2025 (TW) 114111693

(51) Int. Cl. G06F 13/38

(52) U.S. Cl. CPC G06F 13/382; G06F 2213/0026; G06F 2213/0042

(57) ABSTRACT

A controlling circuit is provided. The controlling circuit includes a routing circuit, an upstream facing port (UFP) interface circuit, and a downstream facing port (DFP) interface circuit. The routing circuit includes an adapter circuit and an enhanced superspeed function circuit. The UFP interface circuit is coupled to a USB host device and the routing circuit based on a first transmission specification. The DFP interface circuit is coupled to the routing circuit and a storage device based on a second transmission specification. The adapter circuit is coupled to the DFP interface circuit through the enhanced superspeed function circuit based on a first tunneling protocol to form a first transmission path, and is coupled to the DFP interface circuit through the UFP interface circuit and the enhanced superspeed function circuit based on a second tunneling protocol to form a second transmission path, thereby improving a data access performance.

### CROSS-REFERENCE TO RELATED APPLICATION

This application claims the priority benefit of Taiwan application serial no. 114111693, filed on Mar. 27, 2025. The entirety of the above-mentioned patent application is hereby incorporated by reference herein and made a part of this specification.

### BACKGROUND

### Technical Field

The disclosure relates to a controlling circuit, and particularly relates to a controlling circuit applicable to bridge a universal serial bus (USB) host device and a storage device.

### Description of Related Art

Universal serial bus (USB) is a communication standard for connecting a computer device and other devices. USB includes multiple protocols to indicate various transmission speeds and transmission modes. Generally, a bridge circuit may, for example, bridge a USB host and other devices applying different communication standards based on tunneling protocols in USB specifications.

However, current bridge circuits need to operate cooperatively with external devices such as switches or control units to bridge a USB host and one or more storage devices. The storage devices may, for example, be non-volatile memory express (NVMe) devices. Thus, the host cannot efficiently access one or more NVMe devices through the bridge circuit, and a data access performance is thereby decreased.

### SUMMARY

An embodiment of the disclosure provide a controlling circuit, applicable to bridge a universal serial bus (USB) host device and at least one storage device, and capable of improving a data access performance.

A controlling circuit in an embodiment of the disclosure includes a routing circuit, an upstream facing port interface circuit, and a downstream facing port interface circuit. The routing circuit includes an adapter circuit and an enhanced superspeed function circuit. The upstream facing port interface circuit is configured to couple the USB host device, the adapter circuit, and the enhanced superspeed function circuit based on a first transmission specification. The downstream facing port interface circuit is configured to couple the adapter circuit, the enhanced superspeed function circuit, and the storage device based on a second transmission specification. The adapter circuit is coupled to the downstream facing port interface circuit through the enhanced superspeed function circuit based on a first tunneling protocol to form a first transmission path, and coupled to the downstream facing port interface circuit through the upstream facing port interface circuit and the enhanced superspeed function circuit based on a second tunneling protocol to form a second transmission path.

Based on the above, the controlling circuit in the embodiments of the disclosure forms corresponding transmission paths through the adapter circuit based on various tunneling protocols, and thus the data access performance of the USB host device to the storage device may be improved.

To make the features and advantages of the disclosure more comprehensible, several embodiments accompanied with drawings are described in detail as follows.

### BRIEF DESCRIPTION OF THE DRAWINGS

FIG. 1 is a circuit block diagram of a controlling circuit illustrated according to an embodiment of the disclosure.

FIG. 2 is a circuit block diagram of a controlling circuit illustrated according to another embodiment of the disclosure.

### DESCRIPTION OF THE EMBODIMENTS

Some of the exemplary embodiments of the disclosure will be described in detail with the accompanying drawings. The reference numerals used in the following description will be regarded as the same or similar components when the same reference numerals appear in different drawings. These exemplary embodiments are only a part of the disclosure, and do not disclose all of the ways in which this disclosure may be implemented. More specifically, these exemplary embodiments are only examples of the device and method in the claims of the disclosure.

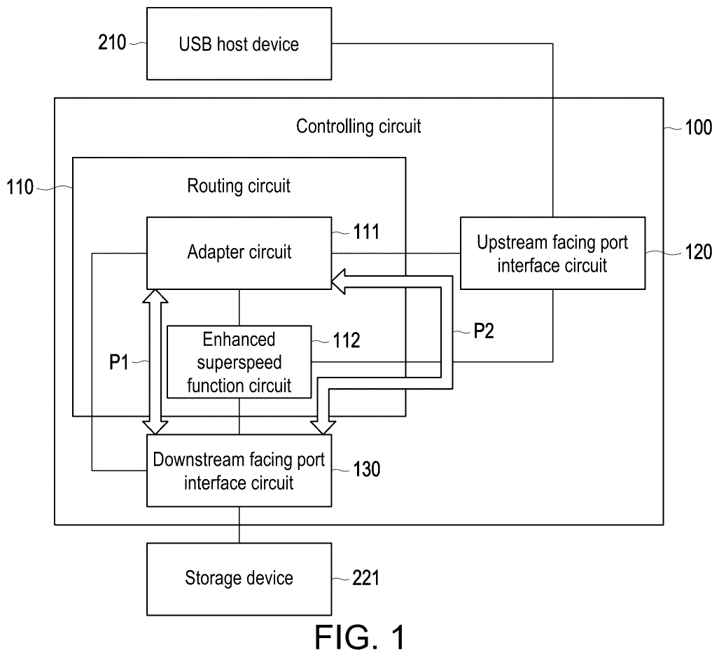

FIG. 1 is a circuit block diagram of a controlling circuit illustrated according to an embodiment of the disclosure. Referring to FIG. 1, a controlling circuit 100 bridges a universal serial bus (USB) host device 210 and at least one storage device 221. The controlling circuit 100 may couple the USB host device 210 based on a first transmission specification, and may couple the storage device 221 based on a second transmission specification. In this embodiment, the first transmission specification may, for example, be a USB specification or a Thunderbolt (TBT) specification. The second transmission specification may, for example, be a peripheral component interconnect express (PCI express, PCIe) specification.

In this embodiment, the USB host device 210 may directly access the storage device 221 through the controlling circuit 100. The USB host device 210 may, for example, be an electronic device applying USB as a transmission interface, such as a mobile phone, a computer device, a tablet computer, a notebook computer, and a desktop computer.

In this embodiment, the storage device 221 may, for example, be a non-volatile memory express (NVMe) device. The storage device 221 may, for example, be a solid-state disk (SSD) or a hard disk drive (HDD).

In the embodiment of FIG. 1, the controlling circuit 100 includes a routing circuit 110, an upstream facing port (UFP) interface circuit 120, and a downstream facing port (DFP) interface circuit 130. The routing circuit 110 includes an adapter circuit 111 and an enhanced superspeed function circuit 112.

In this embodiment, the upstream facing port interface circuit 120 is configured to couple the USB host device 210, the adapter circuit 111, and the enhanced superspeed function circuit 112 based on the first transmission specification. The downstream facing port interface circuit 130 is configured to couple the adapter circuit 111, the enhanced superspeed function circuit 112, and the storage device 221 based on the second transmission specification. Additionally, the adapter circuit 111 is coupled to the enhanced superspeed function circuit 112.

Specifically, the adapter circuit 111 is configured to couple the downstream facing port interface circuit 130 through the enhanced superspeed function circuit 112 based on a first tunneling protocol to form a first transmission path P1. In the first transmission path P1, the adapter circuit 111 processes data from the upstream facing port interface circuit 120 based on the first tunneling protocol, and outputs the processed data to the enhanced superspeed function circuit 112. Based on the first tunneling protocol, the processed data conforms to the first transmission specification (e.g., USB3), and may, for example, be transmitted at a first bandwidth.

Next, in the first transmission path P1, the enhanced superspeed function circuit 112 processes data from the adapter circuit 111, and outputs the processed data to the downstream facing port interface circuit 130. The processed data conforms to the second transmission specification (e.g., PCIe). Thus, the downstream facing port interface circuit 130 accesses the data to the storage device 221.

Additionally, the adapter circuit 111 is further configured to couple the downstream facing port interface circuit 130 through the upstream facing port interface circuit 120 and the enhanced superspeed function circuit 112 based on a second tunneling protocol to form a second transmission path P2. In the second transmission path P2, the adapter circuit 111 processes data from the upstream facing port interface circuit 120 based on the second tunneling protocol, and outputs the processed data to the enhanced superspeed function circuit 112 through the upstream facing port interface circuit 120. Based on the second tunneling protocol, the processed data conforms to the first transmission specification (e.g., USB3), and may, for example, be transmitted at a second bandwidth. The second bandwidth may, for example, be smaller than the first bandwidth. In the second transmission path P2, operations of the enhanced superspeed function circuit 112 and the downstream facing port interface circuit 130 may refer to the above description regarding the first transmission path P1 by analogy.

It is worth mentioning that, through the adapter circuit 111, multiple transmission paths P1 to P2 conforming to the first transmission specification (e.g., USB3) are formed between the adapter circuit 111 and the downstream facing port interface circuit 130 based on various tunneling protocols, and data may be transmitted in the corresponding transmission paths P1 or P2 at the first bandwidth or the second bandwidth. Thus, the controlling circuit 100 may bridge the USB host device 210 and the storage device 221 without externally connecting other devices, and may improve a data access performance.

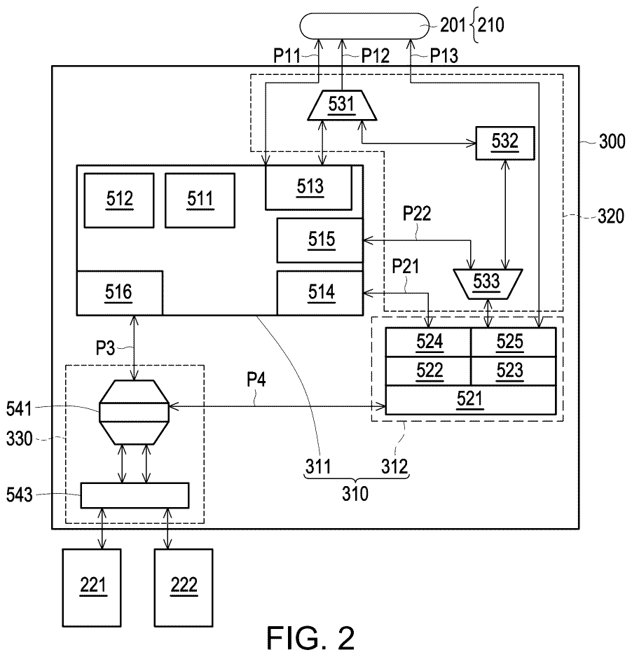

FIG. 2 is a circuit block diagram of a controlling circuit illustrated according to another embodiment of the disclosure. Referring to FIG. 2, a controlling circuit 300 bridges the USB host device 210 and multiple storage devices 221 to 222, wherein the number of these storage devices 221 to 222 is merely illustrative. The controlling circuit 300 is coupled to the USB host device 210 based on a first transmission specification. The first transmission specification may, for example, be a USB specification (e.g., USB4 specification) or a TBT specification (e.g., TBT5 specification). The controlling circuit 300 is further coupled to the multiple storage devices 221 to 222 based on a second transmission specification. The second transmission specification may, for example, be a PCIe specification.

In this embodiment, the USB host device 210 is coupled to the controlling circuit 300 through a connector 201 thereof, and directly accesses the multiple storage devices 221 to 222 through the controlling circuit 300. The connector 201 may, for example, be a USB Type-C connector.

In this embodiment, the multiple storage devices 221 to 222 include SSD and/or HDD. These storage devices 221 to 222 couple the controlling circuit 300 through transmission interfaces applying the second transmission specification (i.e. PCIe specification). The transmission interfaces may, for example, be a serial advanced technology attachment (serial ATA, SATA) transmission interface, a serial attached SCSI (SAS) transmission interface, or a non-volatile memory express (NVMe) transmission interface.

In the embodiment of FIG. 2, the controlling circuit 300 includes a routing circuit 310, an upstream facing port interface circuit 320, and a downstream facing port interface circuit 330. The routing circuit 310 includes an adapter circuit 311 and an enhanced superspeed function circuit 312. The adapter circuit 311, the enhanced superspeed function circuit 312, the upstream facing port interface circuit 320, and the downstream facing port interface circuit 330 may refer to related descriptions of the controlling circuit 100 by analogy.

It should be noted that the adapter circuit 311, the enhanced superspeed function circuit 312, the upstream facing port interface circuit 320, and the downstream facing port interface circuit 330 are disposed on the same chip. That is, the multiple circuits 311 to 312 and 320 to 330 described above are integrated in the same integrated circuit. Thus, the controlling circuit 300 does not require externally connecting other devices to bridge the USB host device 210 and multiple storage devices 221 to 222 to achieve a data access function.

In this embodiment, the adapter circuit 311 is configured to convert data conforming to USB4, USB3, TBT, or PCIe specifications, and to transmit the converted data. Specifically, the adapter circuit 311 may, for example, be a device router supporting USB specifications such as USB3 and USB4, and TBT specifications such as TBT3, TBT4, and TBT5.

Specifically, the adapter circuit 311 includes a control adapter 511, a time management unit (TMU) 512, a lane adapter 513, a first USB adapter 514, a second USB adapter 515, and a PCIe adapter 516. The time management unit 512 is coupled to the control adapter 511 and other multiple adapters 513 to 516. The time management unit 512 is configured to synchronize these adapters 511 and 513 to 516. The control adapter 511 is further coupled to the lane adapter 513, the first USB adapter 514, the second USB adapter 515, and the PCIe adapter 516. The control adapter 511 is configured to control these adapters 513 to 516.

In this embodiment, the lane adapter 513 is further coupled to the upstream facing port interface circuit 320. The lane adapter 513 is configured to process (including convert) data conforming to USB4/TBT specifications or USB3, and transmit the processed data (e.g., USB4 data packets). The lane adapter 513 is further configured to transmit the data (e.g., USB4 data packets) between the lane adapter 513 and the first USB adapter 514, the second USB adapter 515, or the PCIe adapter 516.

In this embodiment, the first USB adapter 514 is further coupled to a first port 524 of the enhanced superspeed function circuit 312. The first USB adapter 514 is configured to process (including convert) data conforming to USB4/TBT specifications or USB3 based on a first tunneling protocol, and transmit the processed data (e.g., USB3.2 data packets) at a first bandwidth. The first tunneling protocol may, for example, be a USB GenT tunneling protocol. The first USB adapter 514 may, for example, be a USB GenT adapter.

In this embodiment, the second USB adapter 515 is further coupled to a second port 525 of the enhanced superspeed function circuit 312 through the upstream facing port interface circuit 320. The second USB adapter 515 is configured to process (including convert) data conforming to USB4/TBT specifications or USB3 based on a second tunneling protocol, and transmit the processed data (e.g., USB3.2 data packets). The second tunneling protocol may, for example, be a USB GenX tunneling protocol. The second USB adapter 515 may, for example, be a USB GenX adapter.

That is, based on the USB GenT tunneling protocol, the first USB adapter 514 may convert USB4 data packets into USB3.2 data packets, and transmit the USB3.2 data packets at the first bandwidth. The first bandwidth may, for example, be the maximum bandwidth available in USB specifications (i.e. USB4 data bandwidth). Based on the USB GenX tunneling protocol, the second USB adapter 515 may convert USB4 data packets into USB3.2 data packets, and transmit the USB3.2 data packets at a second bandwidth. The second bandwidth is smaller than the first bandwidth.

In this embodiment, the PCIe adapter 516 is further coupled to the downstream facing port interface circuit 330. The PCIe adapter 516 is configured to process (including convert) data conforming to USB4/TBT or PCIe specifications based on a third tunneling protocol, and transmit the processed data (e.g., PCIe data packets). The third tunneling protocol may, for example, be a PCIe tunneling protocol. That is, the PCIe adapter 516 may convert USB4 data packets into PCIe data packets, and transmit the PCIe data packets.

In this embodiment, an enhanced superspeed function circuit 520 may, for example, be a module circuit supporting the USB3.2 specification. The enhanced superspeed function circuit 520 is configured to convert data conforming to USB3, USB2, or PCIe specifications, and transmit the converted data, to realize an enhanced superspeed transmission function.

Specifically, the enhanced superspeed function circuit 520 includes a virtual high-speed non-volatile memory express (NVM express, NVMe) host 521, a USB3.2 device controller 522, a USB2.0 device controller 523, a first port 524, and a second port 525. The virtual NVMe host 521 is coupled to the USB3.2 device controller 522, the USB2.0 device controller 523, and the downstream facing port interface circuit 330. The virtual NVMe host 521 is configured to control the USB3.2 device controller 522 and the USB2.0 device controller 523, and assign targets needed to be accessed among the multiple storage devices 221 to 222.

In this embodiment, the USB3.2 device controller 522 is coupled to the first port 524, and coupled to the first USB adapter 514 through the first port 524. The USB3.2 device controller 522 is configured to transmit USB3.2 data packets at the first bandwidth. The first port 524 may, for example, be a USB GenT port.

In this embodiment, the USB2.0 device controller 523 is coupled to the second port 525, and coupled to the upstream facing port interface circuit 320 through the second port 525, and further coupled to the second USB adapter 515 through the upstream facing port interface circuit 320. The USB2.0 device controller 523 is configured to transmit USB3.2 data packets at the second bandwidth. The second port 525 may, for example, be a USB GenX port.

In this embodiment, the upstream facing port interface circuit 320 includes a demultiplexer 531, a USB3.2 physical coding sub-layer (PCS) circuit 532, and a multiplexer 533. An input terminal of the demultiplexer 531 is coupled to the connector 201 of the USB host device 210. Multiple output terminals of the demultiplexer 531 are coupled to the lane adapter 513 and the USB3.2 PCS circuit 532. The USB3.2 PCS circuit 532 is further coupled to an input terminal of the multiplexer 533. Another input terminal of the multiplexer 533 is coupled to the second USB adapter 515. An output terminal of the multiplexer 533 is coupled to the second port 525 of the enhanced superspeed function circuit 520.

In this embodiment, the downstream facing port interface circuit 330 includes a PCIe switch controller 541 and a PCIe physical layer circuit 543. The PCIe switch controller 541 is coupled to the PCIe adapter 516, the virtual NVMe host 521, and the PCIe physical layer circuit 543. The PCIe physical layer circuit 543 is further coupled to the multiple storage devices 221 to 222.

In applications of data access, the upstream facing port interface circuit 320 is coupled to the USB host device 210 through the connector 201 and may form one of multiple transmission paths P11 to P13. Based on a transmission specification of data, the upstream facing port interface circuit 320 transmits the data to the routing circuit 310, such that the routing circuit 310 converts the data into data conforming to the PCIe specification. The routing circuit 310 transmits the data conforming to the PCIe specification to the downstream facing port interface circuit 330 and may form a transmission path P3 or P4. The downstream facing port interface circuit 330 accesses the data conforming to the PCIe specification to the multiple storage devices 221 to 222 through the PCIe physical layer circuit 543.

Specifically, in the transmission path P11, the upstream facing port interface circuit 320 transmits USB4 data packets between the connector 201 and the adapter circuit 311 through a sideband (SB) channel (i.e. SBTX/RX). The adapter circuit 311 transmits the USB4 data packets to the PCIe adapter 516 through the lane adapter 513.

Next, the adapter circuit 311 converts USB4 data packets into PCIe data packets based on the third tunneling protocol (i.e. PCIe tunneling protocol) through the PCIe adapter 516. The adapter circuit 311 is further coupled to the downstream facing port interface circuit 330 based on the third tunneling protocol through the PCIe adapter 516 to form a transmission path P3. In the transmission path P3, the PCIe adapter 516 transmits the PCIe data packets to the downstream facing port interface circuit 330, such that the downstream facing port interface circuit 330 accesses the PCIe data packets to the multiple storage devices 221 to 222.

In the transmission path P12, the upstream facing port interface circuit 320 couples the connector 201 and the adapter circuit 311 together through the demultiplexer 531 to transmit USB3 data packets between the connector 201 and the adapter circuit 311. The adapter circuit 311 converts USB3 data packets into USB GenX data packets based on the second tunneling protocol (i.e. USB GenX tunneling protocol) through the second USB adapter 515. Based on the second tunneling protocol, the second USB adapter 515 transmits USB3.2 data packets at the second bandwidth through the multiplexer 533 to the second port 525 of the enhanced superspeed function circuit 312, to form a transmission path P22.

Next, the enhanced superspeed function circuit 312 converts USB3.2 data packets into PCIe data packets through the virtual NVMe host 521 and the USB2.0 device controller 523. The virtual NVMe host 521 transmits PCIe data packets to the downstream facing port interface circuit 330 to form a transmission path P4. Thus, based on the multiple transmission paths P22 and P4 (i.e. the second transmission path P2 shown in FIG. 1), the downstream facing port interface circuit 330 accesses the PCIe data packets to the multiple storage devices 221 to 222.

Alternatively, in the transmission path P12, the adapter circuit 311 converts USB3 data packets into USB GenT data packets based on the first tunneling protocol (i.e. USB GenT tunneling protocol) through the first USB adapter 514. Based on the first tunneling protocol, the first USB adapter 514 transmits USB3.2 data packets at the first bandwidth to the first port 524 of the enhanced superspeed function circuit 312, to form a transmission path P21.

Next, the enhanced superspeed function circuit 312 converts USB3.2 data packets into PCIe data packets through the virtual NVMe host 521 and the USB3.2 device controller 522. The virtual NVMe host 521 transmits PCIe data packets to the downstream facing port interface circuit 330 to form a transmission path P4. Thus, based on the multiple transmission paths P21 and P4 (i.e. the first transmission path P1 shown in FIG. 1), the downstream facing port interface circuit 330 accesses the PCIe data packets to the multiple storage devices 221 to 222.

It should be noted that, by coupling the adapter circuit 311 and the enhanced superspeed function circuit 312 together through the first USB adapter 514 based on the first tunneling protocol (i.e. USB GenT tunneling protocol), the controlling circuit 300 may transmit USB3.2 data packets at the first bandwidth (i.e. USB4 data bandwidth). Thus, the controlling circuit 300 may use the USB4 data bandwidth to transmit data between the USB host device 210 and the NVM device (e.g., storage device 221), to reduce a tunnel overhead, and increase a throughput of USB3.2 data packets. The controlling circuit 300 may further support asymmetry data transaction.

Alternatively, in the transmission path P12, the upstream facing port interface circuit 320 couples the connector 201 and the second port 525 of the enhanced superspeed function circuit 312 together through the demultiplexer 531, the USB3.2 PCS circuit 532, and the multiplexer 533. Thus, the upstream facing port interface circuit 320 transmits USB3.2 data packets between the connector 201 and the enhanced superspeed function circuit 312 based on the second bandwidth. Next, the enhanced superspeed function circuit 312 converts USB3.2 data packets into PCIe data packets through the virtual NVMe host 521 and the USB2.0 device controller 523, and accesses the PCIe data packets to the downstream facing port interface circuit 330 through the transmission path P4.

In the transmission path P13, the upstream facing port interface circuit 320 couples the connector 201 and the second port 525 of the enhanced superspeed function circuit 312 together through a data channel (i.e. D+/D−). Thus, in the transmission path P13, the upstream facing port interface circuit 320 transmits USB3.2 data packets between the connector 201 and the enhanced superspeed function circuit 312 at the second bandwidth. Next, the enhanced superspeed function circuit 312 converts USB3.2 data packets into PCIe data packets through the virtual NVMe host 521 and the USB2.0 device controller 523, and accesses the PCIe data packets to the downstream facing port interface circuit 330 through the transmission path P4.

In summary, the controlling circuit in the embodiments of the disclosure transmits data through the adapter circuit based on various tunneling protocols, and may bridge a USB host device and a storage device without externally connecting other devices. Additionally, by transmitting USB3.2 data packets through the adapter circuit based on the first tunneling protocol (i.e. USB GenT tunneling protocol), the controlling circuit may use USB4 data bandwidth to transmit data between the USB host device and the storage device. Thus, the controlling circuit may improve a data access performance and a throughput of USB3.2 data packets, and reduce a tunnel overhead.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A controlling circuit, applicable to bridge a universal serial bus (USB) host device and at least one storage device, the controlling circuit comprising:
a routing circuit, comprising an adapter circuit and an enhanced superspeed function circuit;
an upstream facing port interface circuit, coupled to the USB host device, the adapter circuit, and the enhanced superspeed function circuit based on a first transmission specification; and
a downstream facing port interface circuit, coupled to the adapter circuit, the enhanced superspeed function circuit, and the at least one storage device based on a second transmission specification,
wherein the adapter circuit is coupled to the downstream facing port interface circuit through the enhanced superspeed function circuit based on a first tunneling protocol to form a first transmission path, and coupled to the downstream facing port interface circuit through the upstream facing port interface circuit and the enhanced superspeed function circuit based on a second tunneling protocol to form a second transmission path.

2. The controlling circuit according to claim 1, wherein the first transmission specification is a USB specification or a Thunderbolt specification.

3. The controlling circuit according to claim 1, wherein the second transmission specification is a peripheral component interconnect express (PCIe) specification.

4. The controlling circuit according to claim 1, wherein the first tunneling protocol is a USB GenT tunneling protocol, and the second tunneling protocol is a USB GenX tunneling protocol.

5. The controlling circuit according to claim 1, wherein the adapter circuit comprises:
a lane adapter, coupled to the upstream facing port interface circuit;
a first USB adapter, coupled to a first port of the enhanced superspeed function circuit;
a second USB adapter, coupled to a second port of the enhanced superspeed function circuit through the upstream facing port interface circuit;
a PCIe adapter, coupled to the downstream facing port interface circuit;
a control adapter, coupled to the lane adapter, the first USB adapter, the second USB adapter, and the PCIe adapter; and
a time management unit, coupled to the lane adapter, the first USB adapter, the second USB adapter, the PCIe adapter, and the control adapter.

6. The controlling circuit according to claim 5, wherein the enhanced superspeed function circuit comprises:
the first port, coupled to the first USB adapter;
the second port, coupled to the upstream facing port interface circuit;
a USB3.2 device controller, coupled to the first port;
a USB2.0 device controller, coupled to the second port; and
a virtual non-volatile memory express (NVMe) host, coupled to the USB2.0 device controller, the USB3.2 device controller, and the downstream facing port interface circuit.

7. The controlling circuit according to claim 6, wherein the upstream facing port interface circuit comprises:
a USB3.2 physical coding sub-layer (PCS) circuit;
a demultiplexer, having an input terminal coupled to the USB host device, a plurality of output terminals of the demultiplexer being coupled to the lane adapter and the USB3.2 PCS circuit; and
a multiplexer, having a plurality of input terminals coupled to the second USB adapter and the USB3.2 PCS circuit, an output terminal of the multiplexer being coupled to the second port of the enhanced superspeed function circuit.

8. The controlling circuit according to claim 7, wherein the downstream facing port interface circuit comprises:
a PCIe switch controller, coupled to the PCIe adapter and the virtual NVMe host; and
a PCIe physical layer circuit, coupled to the PCIe switch controller.

9. The controlling circuit according to claim 1, wherein the adapter circuit is further coupled to the downstream facing port interface circuit based on a third tunneling protocol to form a third transmission path.

10. The controlling circuit according to claim 9, wherein the third tunneling protocol is a PCIe tunneling protocol.

11. The controlling circuit according to claim 1, wherein the adapter circuit, the enhanced superspeed function circuit, the upstream facing port interface circuit, and the downstream facing port interface circuit are disposed on a same chip.
